(19) United States
(12) Patent Application Publication
(10) Pub. No.: US 2025/0046011 A1
(43) Pub. Date: Feb. 6, 2025

(54) INSTALLING ONE OR MORE CAMERAS AND DETECTING HAZARDOUS EVENTS

(71) Applicant: AiLert Inc., Wilmington, DE (US)

(72) Inventors: Joachim Levy, Raanana (IL); Serhii Marushak, Wilmington, DE (US); Nery Strasman, Wilmington, DE (US)

(73) Assignee: AiLert Inc., Wilmington, DE (US)

(21) Appl. No.: 18/365,926

(22) Filed: Aug. 4, 2023

(51) Int. Cl. G06T 17/00; G06T 7/00

(52) U.S. Cl. CPC G06T 17/00; G06T 7/0002; G06T 2207/20081

(57) ABSTRACT

A method for installing a camera, the method may include acquiring images of a space to be monitored by the camera; generating a three dimensional (3D) model of the space, based on the images; determining capabilities of the camera to acquire one or more visual identifiers of one or more hazardous events of a set of hazardous events, under different camera installation candidates; and selecting a selected camera installation out of the different camera installation candidates, based on the capabilities.

### BACKGROUND

Automatic systems that detect and identify events or specific conditions are on the rise. In many cases, cameras are located at places that need to be protected. The events that require immediate detection include crimes, potential violence (such as identifying people carrying weapons), fire, flooding, accidents, etc. A preferred method of performing these automatic tasks, is by using Machine Learning (ML) techniques. This involves training systems to detect and identify such events. Machine Learning, in most cases, involves training the system by providing it with cases it needs to identify and those that it doesn't.

For best results, there will usually be ideal places to locate the cameras in order to identify and detect events. A location may include both the physical coordinates and the angular inclinations of the camera. For example, it might be best to locate a camera at a high position so that less objects may be occluded by other objects. Of course, this might mean that only some aspects of the objects or people seen in the camera may appear in the viewpoint. So, for example, it might be beneficial to place a camera in the ceiling of a room for a specific purpose but that would mean that identifying specific people may become impossible because faces will not be seen by the camera. The different considerations as to where to place the camera, may include lighting conditions, color, size and shape of the background, what needs to be identified or detected, camera parameters, etc.

Sometimes it is beneficial to send an expert to the location in order to decide where to locate the camera for the given task. But this may not be possible. For example, the location may be distant from an expert, or may be difficult to access for some reasons. Additionally, while the expert would probably choose a better location for the camera than a layman, the expert might still not choose the best or optimal place to locate the camera for many reasons, including the fact that eventually it is a machine that performs the detection of the event.

There is a growing need to provide an accurate system for finding where to locate cameras for detecting hazardous events.

### SUMMARY

There may be provided a method, a system and a non-transitory computer readable medium for installing one or more cameras.

### BRIEF DESCRIPTION OF THE DRAWINGS

FIGS. 1-2 illustrate an example of a space;

FIG. 3 illustrates an example of images of the space;

FIG. 4 illustrates an example of a model of the space;

FIGS. 5-11 illustrate examples of camera installation candidates; and

FIGS. 12-13 illustrate examples of methods.

### DESCRIPTION OF THE DRAWINGS

In the following detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

Any reference in the specification to a method should be applied mutatis mutandis to a system capable of executing the method and should be applied mutatis mutandis to a computer readable medium that is non-transitory and stores instructions for executing the method.

Any reference in the specification to a system should be applied mutatis mutandis to a method that may be executed by the system and should be applied mutatis mutandis to a computer readable medium that is non-transitory and stores instructions executable by the system.

Any reference in the specification to a computer readable medium that is non-transitory should be applied mutatis mutandis to a method that may be applied when executing instructions stored in the computer readable medium and should be applied mutatis mutandis to a system configured to execute the instructions stored in the computer readable medium.

The term “and/or” means additionally or alternatively.

In would be best to let a computerized process choose the best location.

The solution may include (i) images of the space to be monitored should be acquired by an enquiring camera-such as a smartphone's camera. (ii) the footage collected by the enquiring camera is then used to create a three dimensional (3D) model of the space—for example, if a camera is to be located in an office, the space of the office can be scanned with a camera to cover all of the inside of the office, (iii) virtually locating one or more monitoring cameras at different places within the 3D model and seeing the results it gets for the detecting tasks, for this, additional objects may be added to the model, and (iv) choosing the best location for the one or more monitoring cameras by applying an iterative process which compares the results derived by placing the one or more monitoring cameras at different locations. The process itself may be aided by artificial intelligence (AI).

Once the location is chosen, it is possible to place the camera at its optimal place. Note that this process may also include defining camera parameters such as zoom or other parameters.

The choosing of the best location and/or a selection of a location and/or the evaluation of the capabilities of the one or more camera may be based on detection of one or more hazardous events. It should be noted that the detection of other events and/or other objects may be taken into account. For example the selection may apply any weight or any importance or any priority to the detection of any hazardous event and/or to a detection or any other event and/or to a detection of any object.

Any reference to a hazardous event should be applied mutatis mutandis to a combination of a hazardous event and a non-hazardous event and/or an object and/or should be applied, mutatis mutandis to a combination of a hazardous event and a non-hazardous object.

Any reference to a hazardous event should be applied mutatis mutandis to a non-hazardous event and/or an object.

The detection of hazardous events can be made based on a machine learning process.

For example, if the hazardous event that needs to be detected is a person carrying a gun, then a real person carrying a gun would need to appear in the camera's field of view, under various conditions (such as different lighting conditions, wearing different types of clothes, be partially obscured by other people or objects, etc.).

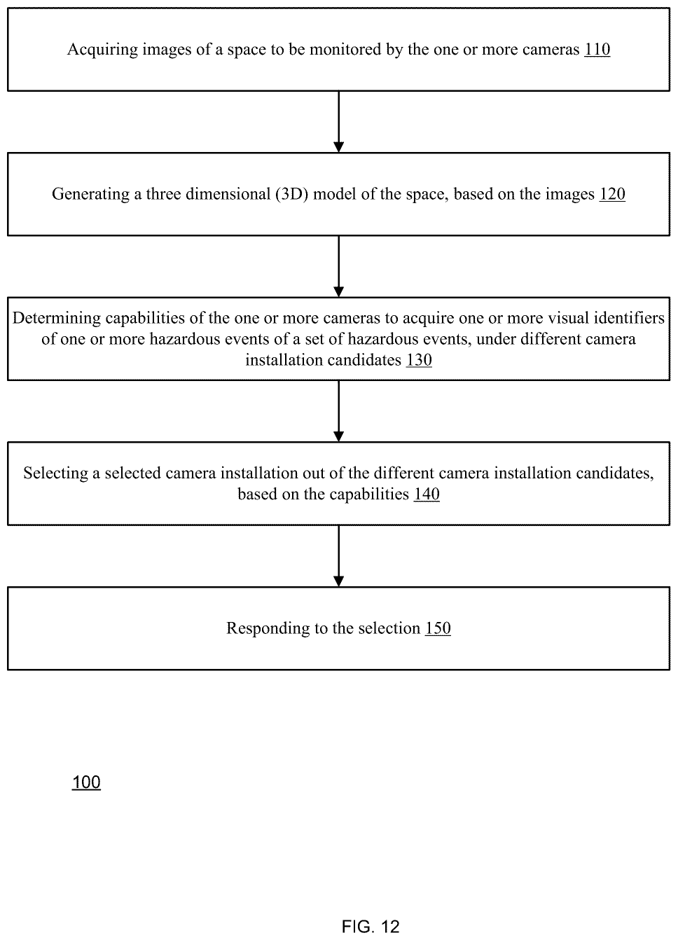

FIG. 12 illustrates an example of method 100 for installing one or more cameras.

Method 100 may start by step 110 of acquiring images of a space to be monitored by the one or more cameras. The acquisition may include taking various images of the space-preferably from different viewpoints-some of which differ from each other by their angle.

The images do not require a preliminary installation of the one or more camera—and may, for example, be acquired by another type of camera (referred to as an enquiring camera)—that may be simpler and/or more mobile than the installed one or more cameras (referred to as one or more monitoring cameras)—although this is not necessarily so.

Step 110 may be followed by step 120 of generating a three dimensional (3D) model of the space, based on the images. Step 120 may be executed in any manner.

Step 120 may be followed by step 130 of determining capabilities of the one or more cameras to acquire one or more visual identifiers of one or more hazardous events of a set of hazardous events, under different camera installation candidates.

At least some of the different camera installations may be determined based on installation limitations. Installation limitations may include mechanical limitations and/or environmental conditions—for example whether a camera may be installed at a certain location—for example whether the wall may support a camera pedestal, whether a certain location is wide enough to accommodate a camera, location of nearby power sockets, wireless communication dead spots that will not allow the camera to wirelessly communicate, wetness or humidity of certain areas, temperature of certain areas, and the like.

Method 100 may include receiving information about the set of hazardous events and/or generating at least some of the hazardous events. The information may include visual identifiers of hazards—for example a “person carrying a gun” visual identifier.

The capabilities may be evaluated by simulating hazardous events—for example simulating a man that carries a gun at a presence of other persons and/or objects that conceal the gun from the cameras.

The capabilities may be evaluated by checking occlusions.

The determining of the at least some of the hazardous events may be based on previous installations-especially hazardous events detected by one or more installed cameras at other spaces.

Step 130 may be followed by step 140 of selecting a selected camera installation out of the different camera installation candidates, based on the capabilities.

A capability may include detecting a hazardous event but may include one or more additional parameters such as the certainty of detection, false positives, false negative, true positives, true negatives, and the like.

Step 130 and/or step 140 may be executed using machine learning. The machine learning may be trained to detect hazardous events. An example for detecting hazardous events is illustrated in U.S. patent application Ser. No. 18/065,612 which is incorporated herein by reference.

Step 140 may be followed by step 150 of responding to the selection.

Step 150 may include installing the one or more cameras according to the selected camera installation.

Step 150 may include detecting hazardous events by the one or more cameras.

Step 150 may include responding to the detecting of a hazardous event. The responding may include generating an alert, attempting to solve or cope with the hazardous event, prevent access to an asset that is secured by the camera, and the like. The alert may be a human perceivable hazardous event alert. The alert may be sent over one or more communication links to responders such as the police, firefighters, medical assistance personnel, hazardous materials disposal units, and the like.

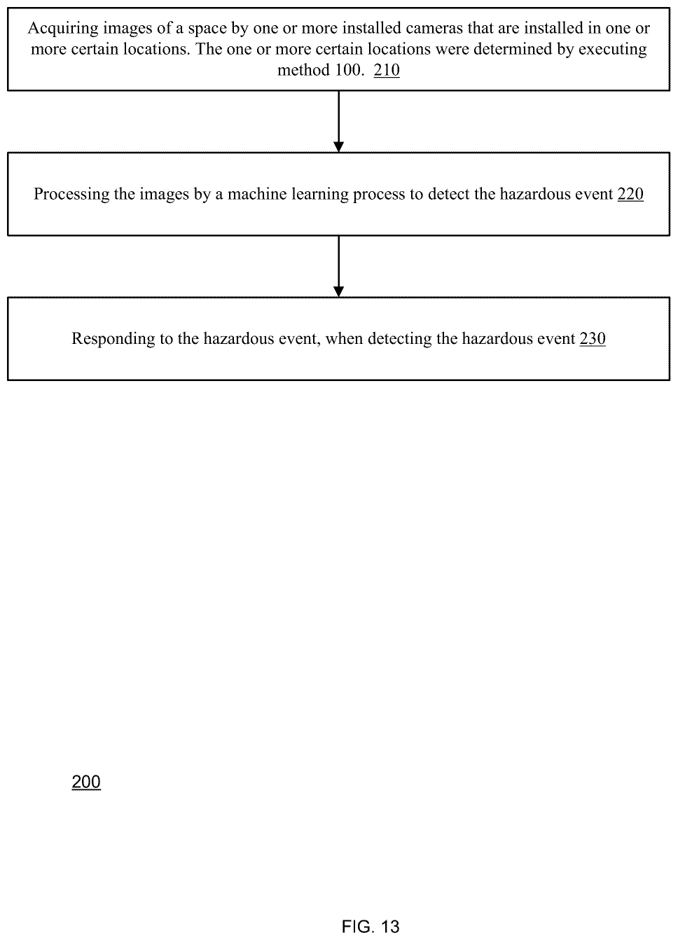

FIG. 13 illustrates a method 200 for detecting one or more hazardous events.

Method 200 may start by step 210 of acquiring images of a space by one or more installed cameras that are installed in one or more certain locations. The one or more certain locations were determined by executing method 100. For example—the one or more certain locations may be determined by (i) acquiring images of the space; (ii) generating a three dimensional (3D) model of the space, based on the images; (iii) determining capabilities of the one or more cameras to acquire one or more visual identifiers of one or more hazardous events of a set of hazardous events, under different camera installation candidates; and (iv) selecting the certain location out of the different camera installation candidates, based on the capabilities.

Step 210 may be followed by step 220 of processing the images by a machine learning process to detect the hazardous event.

Step 220 may be followed by step 230 of responding to the hazardous event, when detecting the hazardous event.

The responding may include generating an alert, closing a door, performing an access prevention step, neutralizing an aggressor (for example by directing a jet of fluid, directing gas, shooting at the aggressor, electrically shocking the aggressor), and the like.

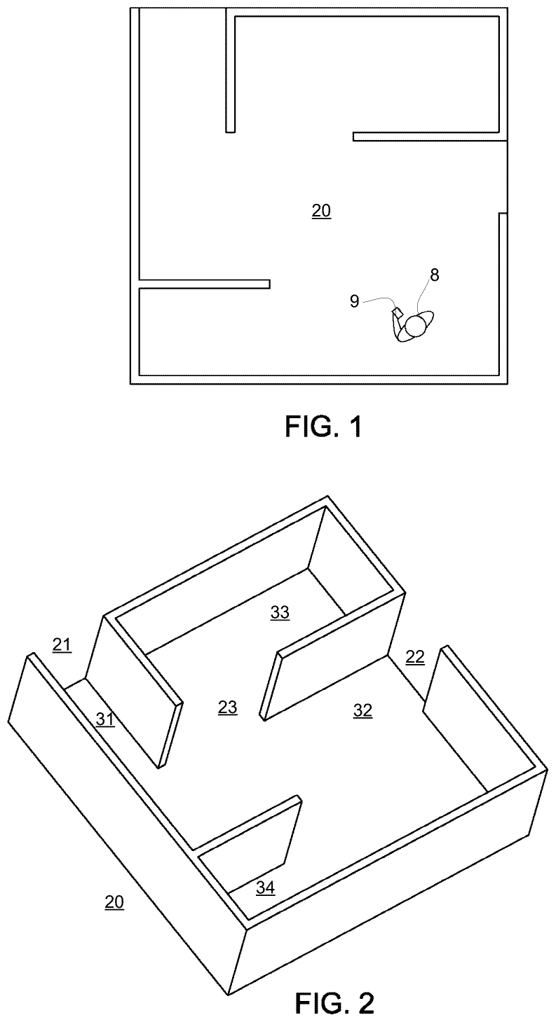

FIG. 1 illustrates an example of a top view of a space 20 within a building and of a person 8 that captures images of the space using his smartphone 9. FIG. 2 illustrates space 20 as including a first opening 21, a corridor 31, a main sub-space 32, a room 33, an additional sub-space 34, a second opening 22 and a third opening 23.

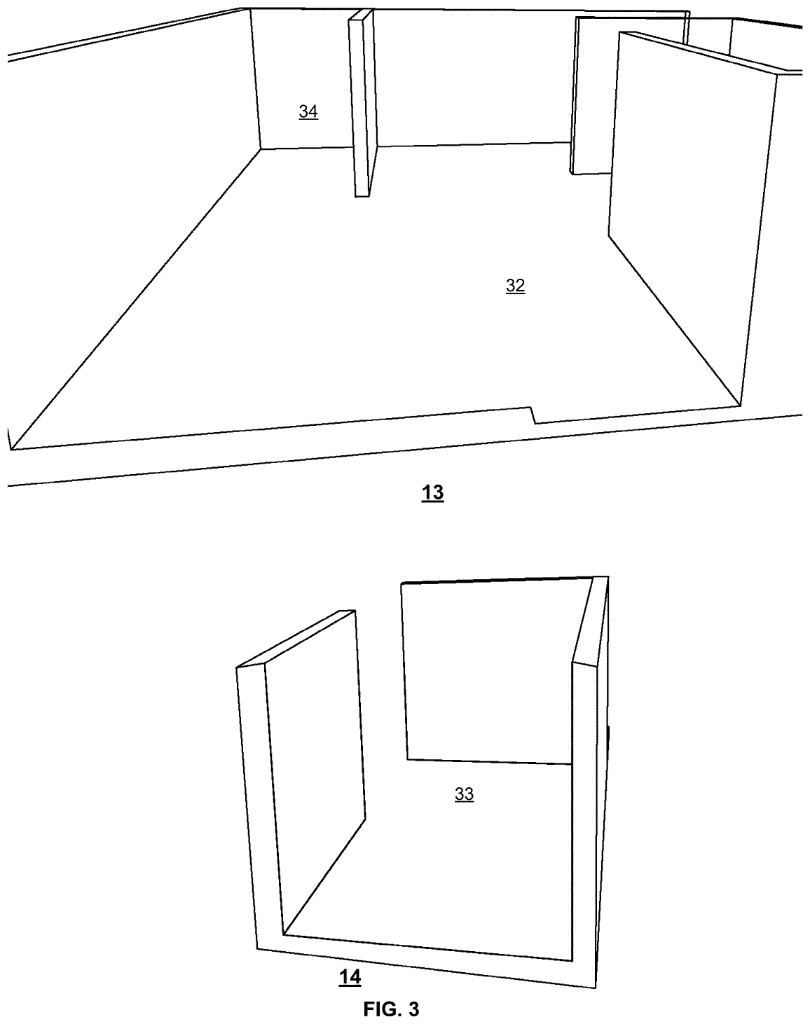

FIG. 3 illustrates images 13 and 14 of parts of the space from different view points.

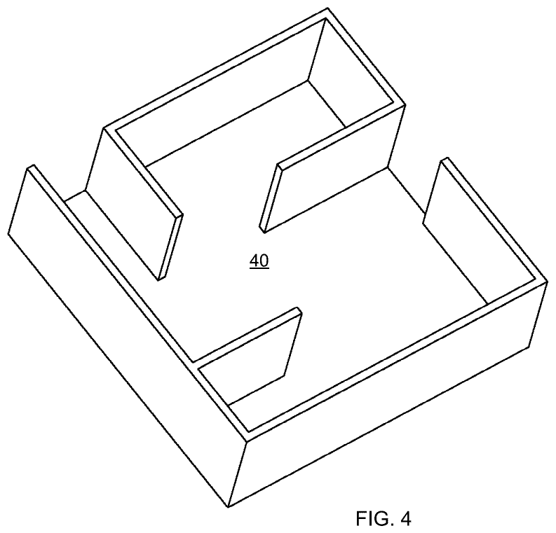

FIG. 4 illustrates a 3D model 40 of space 20.

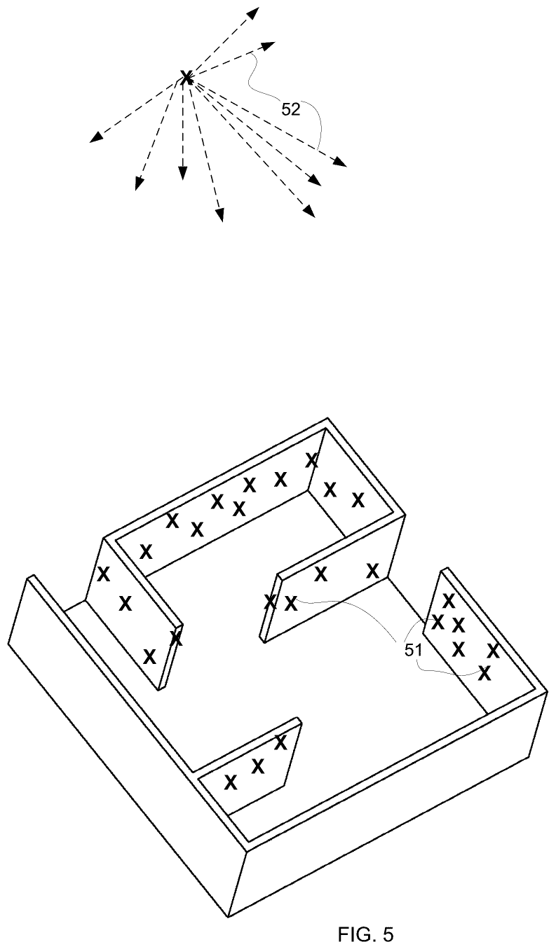

FIG. 5 illustrates examples of different camera installation candidates that include different camera orientations 52 and different camara locations 51 within space 20.

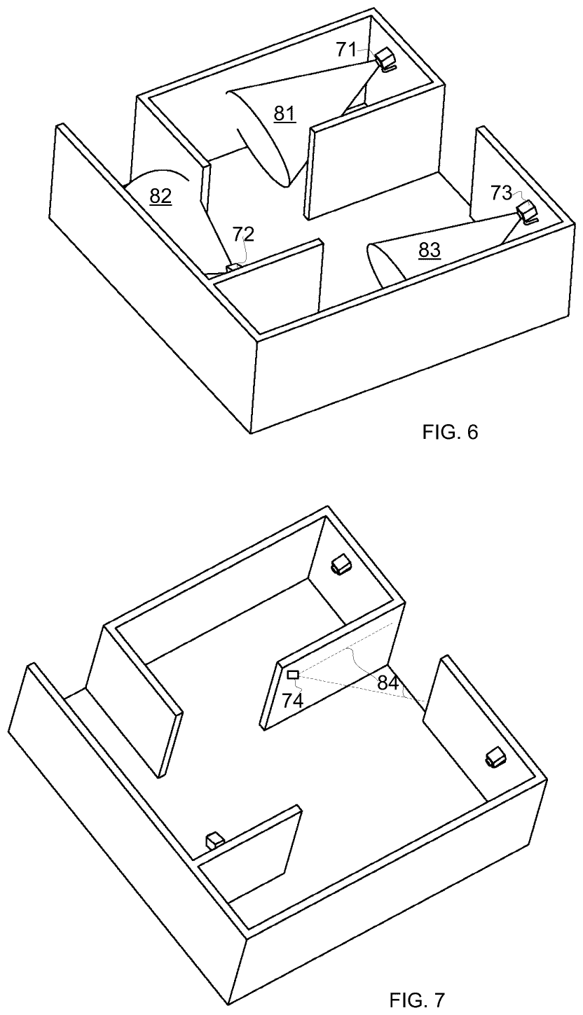

FIG. 6 illustrates a camera installation candidate that includes three cameras 71, 72 and 73 having fields of views 81, 82 and 83 respectively.

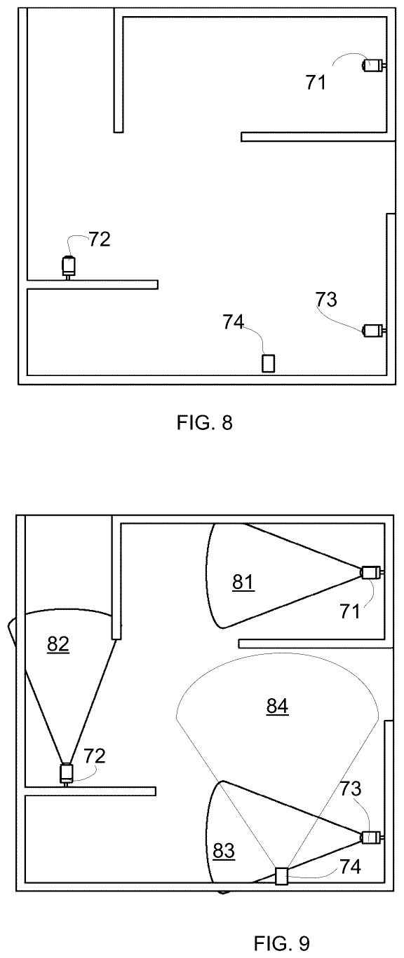

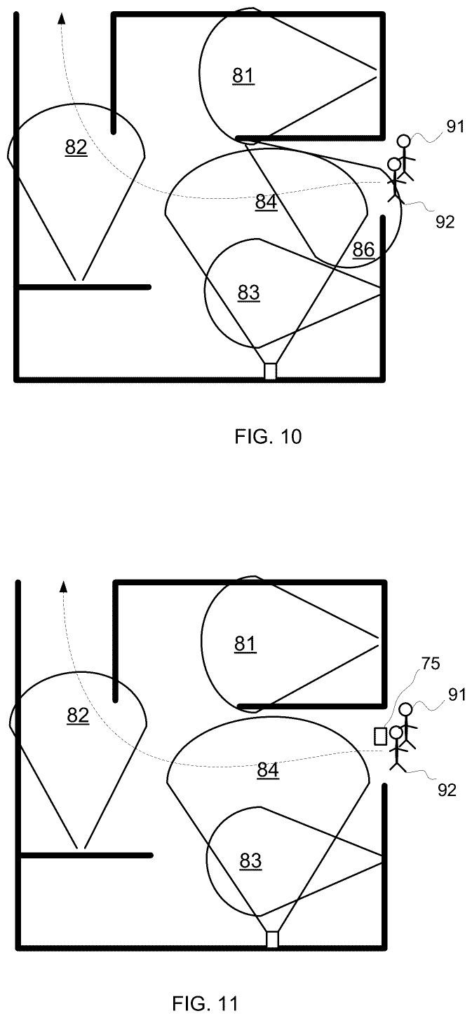

FIGS. 7, 8 and 9 illustrates another camera installation candidate that includes four cameras 71, 72, 73 and 74 having four fields of views. FIG. 7 illustrates a fourth field of view 84. FIG. 9 illustrates fields of view 81, 83, 83 and 84.

FIG. 10 illustrates another camera installation candidate that includes five cameras having five fields of views 81, 82, 83, 84, and 86. FIG. 10 also illustrates an hazardous event in which two persons 91 and 92 enter space 20 through the second opening, pass through space 20 and exit through the first opening. One of the persons carries a gun and he may be occluded by the second person. This hazardous event may not be captured using fewer cameras. Assuming that first person 91 carries a gun
this may not be detected by the camera installation candidates of FIG. 6.

FIG. 11 illustrates another camera installation candidate that includes five cameras (including camera 75 located at a ceiling of the space and looking downwards at the second opening) having five fields of views of which fields of views 81, 82, 83, 84 are shown. FIG. 11 also illustrates a hazardous event in which two persons 91 and 92 enter space 20 through the second opening, pass through space 20 and exit through the first opening. One of the persons carries a gun and he may be occluded by the second person.

The terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the disclosure described herein are, for example, capable of operation in other orientations than those illustrated or otherwise described herein.

The connections as discussed herein may be any type of connection suitable to transfer signals from or to the respective nodes, units, or devices, for example via intermediate devices. Accordingly, unless implied or stated otherwise, the connections may for example be direct connections or indirect connections. The connections may be illustrated or described in reference to be a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments of the disclosure s containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the embodiments of the disclosure.

We claim:

1. A method for installing a camera, the method comprises:
acquiring images of a space to be monitored by the camera;
generating a three dimensional (3D) model of the space, based on the images;
determining capabilities of the camera to acquire one or more visual identifiers of one or more hazardous events of a set of hazardous events, under different camera installation candidates; and
selecting a selected camera installation out of the different camera installation candidates, based on the capabilities.

2. The method according to claim 1, comprising installing the camera according to the selected camera installation.

3. The method according to claim 1, comprising receiving a definition of the set of hazardous events.

4. The method according to claim 1, comprising determining the set of hazardous events based on previous installations.

5. The method according to claim 1, wherein at least one of the determining of the capabilities and the selecting is executed by a machine learning process.

6. The method according to claim 1, wherein the determining of the capabilities comprises checking occlusions.

7. The method according to claim 1, comprising determining the different camera installation candidates based on installation limitations.

8. A non-transitory computer readable medium for installing a camera, the non-transitory computer readable medium stores instructions for:
acquiring images of a space to be monitored by the camera;
generating a three dimensional (3D) model of the space, based on the images;
determining capabilities of the camera to acquire one or more visual identifiers of one or more hazardous events of a set of hazardous events, under different camera installation candidates; and
selecting a selected camera installation out of the different camera installation candidates, based on the capabilities.

9. The non-transitory computer readable medium according to claim 8, that stores instructions for receiving a definition of the set of hazardous events.

10. The non-transitory computer readable medium according to claim 8, that stores instructions for determining the set of hazardous events based on previous installations.

11. The non-transitory computer readable medium according to claim 8, that stores instructions for determining of the capabilities by checking occlusions.

12. The non-transitory computer readable medium according to claim 8, that stores instructions for determining the different camera installation candidates based on installation limitations.

13. A method for detecting one or more hazardous events of a set of hazardous events, the method comprises:
acquiring images of a space by an installed camera that is installed in a certain location; wherein the certain location was determined by (i) acquiring images of the space; (ii) generating a three dimensional (3D) model of the space, based on the images; (iii) determining capabilities of the camera to acquire one or more visual identifiers of one or more hazardous events of a set of hazardous events, under different camera installation candidates; and (iv) selecting the certain location out of the different camera installation candidates, based on the capabilities;
processing the images by a machine learning process to detect the hazardous event; and
responding to the hazardous event when detecting the hazardous event.

14. A machine learning system that is configured to install a camera, the machine learning process comprises a processing circuit that is configured to:
receive acquiring images of a space to be monitored by the camera;
generate a three dimensional (3D) model of the space, based on the images;
determine capabilities of the camera to acquire one or more visual identifiers of one or more hazardous events of a set of hazardous events, under different camera installation candidates; and
select a selected camera installation out of the different camera installation candidates, based on the capabilities.
